(19) United States
(12) Patent Application Publication
(10) Pub. No.: US 2023/0351221 A1
(43) Pub. Date: Nov. 2, 2023

(54) KNOWLEDGE GRAPH REASONING METHOD AND APPARATUS, MODEL TRAINING METHOD AND APPARATUS, AND COMPUTER DEVICE

(71) Applicant: Alipay (Hangzhou) Information Technology Co., Ltd., Hangzhou. (CN)

(72) Inventors: Linlin CHAO, Hangzhou (CN); Taifeng WANG, Hangzhou (CN); Wei CHU, Hangzhou (CN)

(21) Appl. No.: 18/305,279

(22) Filed: Apr. 21, 2023

(30) Foreign Application Priority Data
Apr. 28, 2022 (CN) 202210457668.3

(51) Int. Cl. G06N 5/02

(52) U.S. Cl. CPC G06N 5/022; G06N 3/047

(57) ABSTRACT

Implementations of the present specification disclose a knowledge graph reasoning method and apparatus, a model training method and apparatus, and a computer device. The method includes: obtaining a query entity and a query relationship; selecting one or more nearest neighbor entities of the query entity from a knowledge graph; determining a first probability of a nearest neighbor entity of the one or more nearest neighbor entities, where the first probability is used to indicate a possibility that the nearest neighbor entity is in communication with the query relationship; selecting a nearest neighbor entity of the one or more nearest neighbor entities as a candidate entity based on the first probability; and selecting a candidate entity matching the query entity and the query relationship as a result entity. In the implementations of the present specification, the efficiency of knowledge graph reasoning can be improved.

### TECHNICAL FIELD

Implementations of the present specification relate to the field of computer technologies, and in particular, to a knowledge graph.

### BACKGROUND

Knowledge graphs (KGs) are intended to describe various entities in the real world and relationships between the entities.

Knowledge graph reasoning (KGR) is intended to derive new knowledge from existing knowledge in the knowledge graphs through reasoning. Knowledge graph reasoning has important application values in fields such as question answering and information retrieval.

### SUMMARY

Implementations of the present specification provide a knowledge graph reasoning method and apparatus, a model training method and apparatus, and a computer device, to improve the efficiency of knowledge graph reasoning. The technical solutions provided in the implementations of the present specification are as follows.

A first aspect of the implementations of the present specification provides a knowledge graph reasoning method, including: obtaining a query entity and a query relationship; selecting one or more nearest neighbor entities of the query entity from a knowledge graph; determining a first probability of a nearest neighbor entity of the one or more nearest neighbor entities, where the first probability is used to indicate a possibility that the nearest neighbor entity is in communication with the query relationship; selecting a nearest neighbor entity of the one or more nearest neighbor entities as a candidate entity based on the first probability; and selecting a candidate entity matching the query entity and the query relationship as a result entity.

A second aspect of the implementations of the present specification provides a model training method, including: masking one or more entity relationships of a target entity in a knowledge graph sample; determining type distribution information of the target entity based on a masked knowledge graph sample and a type distribution prediction model, where the type distribution information is used to indicate possibilities that the target entity is in communication with a plurality of known entity relationships; determining a third probability of the target entity based on the type distribution information and the masked entity relationship, where the third probability is used to indicate a possibility that the target entity is in communication with the masked entity relationship; and optimizing a model parameter of the type distribution prediction model based on the third probability.

A third aspect of the implementations of the present specification provides a knowledge graph reasoning apparatus, including: an acquisition unit, configured to obtain a query entity and a query relationship; a first selection unit, configured to select one or more nearest neighbor entities of the query entity from a knowledge graph; a determining unit, configured to determine a first probability of a nearest neighbor entity of the one or more nearest neighbor entities, where the first probability is used to indicate a possibility that the nearest neighbor entity is in communication with the query relationship; a second selection unit, configured to select a nearest neighbor entity of the one or more nearest neighbor entities as a candidate entity based on the first probability; and a third selection unit, configured to select a candidate entity matching the query entity and the query relationship as a result entity.

A fourth aspect of the implementations of the present specification provides a model training apparatus, including: a masking unit, configured to mask one or more entity relationships of a target entity in a knowledge graph sample; an acquisition unit, configured to determine type distribution information of the target entity based on a masked knowledge graph sample and a type distribution prediction model, where the type distribution information is used to indicate possibilities that the target entity is in communication with a plurality of known entity relationships; a determining unit, configured to determine a third probability of the target entity based on the type distribution information and the masked entity relationship, where the third probability is used to indicate a possibility that the target entity is in communication with the masked entity relationship; and an optimization unit, configured to optimize a model parameter of the type distribution prediction model based on the third probability.

A fifth aspect of the implementations of the present specification provides a computer device, including: at least one processor; and a memory storing program instructions, where the program instructions are configured to be applicable to be executed by the at least one processor, and the program instructions include instructions used for performing the method according to the first aspect or the second aspect.

According to the technical solutions provided in the implementations of the present specification, the query entity and the query relationship can be obtained, the nearest neighbor entity of the query entity can be selected from the knowledge graph, the first probability of the nearest neighbor entity can be determined, the nearest neighbor entity can be selected as the candidate entity based on the first probability, and the candidate entity matching the query entity and the query relationship can be selected as the result entity. As such, an entity in the knowledge graph can be screened based on the query entity to obtain the nearest neighbor entity, and the nearest neighbor entity can be screened based on the first probability to obtain the candidate entity. Therefore, the number of candidate entities can be reduced, and the efficiency of knowledge graph reasoning can be improved. In addition, according to the technical solutions provided in the implementations of the present specification, the entity relationship of the target entity in the knowledge graph sample is masked, to train the type distribution prediction model. As such, the type distribution prediction model can be trained in a self-monitoring way without labeling the knowledge graph sample. The trained type distribution prediction model is used to determine the type distribution information.

### BRIEF DESCRIPTION OF DRAWINGS

To describe the technical solutions in the implementations of the present specification or in the existing technologies more clearly, the following is a brief introduction of the accompanying drawings for illustrating such technical solutions. The accompanying drawings described below are merely some implementations of the present specification, and a person of ordinary skill in the art can derive other accompanying drawings from such accompanying drawings without making innovative efforts.

FIG. 1 is a schematic flowchart illustrating a knowledge graph reasoning method according to an implementation of the present specification;

FIG. 2 is a schematic diagram illustrating a process of knowledge graph reasoning according to an implementation of the present specification;

FIG. 3 is a schematic diagram illustrating type distribution information according to an implementation of the present specification;

FIG. 4 is a schematic diagram illustrating a graph neural network model according to an implementation of the present specification;

FIG. 5 is a schematic flowchart illustrating a model training method according to an implementation of the present specification;

FIG. 6 is a schematic diagram illustrating a structure of a knowledge graph reasoning apparatus according to an implementation of the present specification;

FIG. 7 is a schematic diagram illustrating a structure of a model training apparatus according to an implementation of the present specification; and

FIG. 8 is a schematic diagram illustrating a structure of a computer device according to an implementation of the present specification.

### DETAILED DESCRIPTION

The following describes the technical solutions in the example implementations of the present specification with reference to the accompanying drawings in the implementations of the present specification. Clearly, the described implementations are merely some rather than all of the implementations of the present specification. All other implementations obtained by a person of ordinary skill in the art based on the implementations of the present specification without making innovative efforts shall fall within the protection scope of the present specification.

In the real world, there are various entities (for example, companies, cities, users, devices, commodities, user social accounts, images, text, audio data, etc.). The entities can be from but are unnecessarily from the financial industry, the insurance industry, the Internet industry, the automotive industry, the foodservice industry, the telecommunications industry, the energy industry, the entertainment industry, the sports industry, the logistics industry, the medical industry, the security industry, etc. Graph data can be constructed based on the entities and relationships between the entities. The graph data can include nodes and edges. The node is used to represent the entity, and the edge is used to represent a relationship between entities. If a node is connected to an edge, it indicates that an entity corresponding to the node is in communication with an entity relationship corresponding to the edge; or if a node is not connected to an edge, it indicates that an entity corresponding to the node is not in communication with an entity relationship corresponding to the edge. The graph data can include directed graph data and undirected graph data. The edge in the directed graph data has a direction, and the edge in the undirected graph data has no direction. In practice, based on different entity types, the graph data can include a social graph (the node represents a user, and the edge represents a user relationship), a device network graph (the node represents a network device, and the edge represents a communication relationship), a transfer graph (the node represents a user account, and the edge represents a fund flow relationship), etc.

The graph data can be used to represent a knowledge graph. For example, the graph data can include a social graph, a device network graph, a transfer graph, and a corresponding knowledge graph can include a social knowledge graph, a device network knowledge graph, a transfer knowledge graph, etc.

The knowledge graph can include a plurality of triplets. The triplet can be used to represent knowledge. The triplet includes a head entity, an entity relationship, and a tail entity. The head entity is in communication with the entity relationship, and the entity relationship is in communication with the tail entity. As such, the entity relationship exists between the head entity and the tail entity. For example, the triplet can be represented as (h, r, t), where h represents the head entity, r represents the entity relationship, and t represents the tail entity. Knowledge graph reasoning can mean obtaining a missing element through reasoning when two elements in the triplet are given. For example, head entity h and entity relationship r in the triplet are given, and tail entity t is obtained through reasoning. For another example, entity relationship r and tail entity tin the triplet are given, and head entity h is obtained through reasoning.

In some example technology, a process of knowledge graph reasoning is as follows: A query entity and a query relationship are obtained, an entity in a knowledge graph is used as a candidate entity, and the knowledge graph is traversed to select a candidate entity matching the query entity and the query relationship as a result entity. For example, a rule-based reasoning method or a representation learning-based reasoning method can be used to select a candidate entity as a result entity. However, the number of entities in the knowledge graph is relatively large, if the entities in the knowledge graph are directly used as candidate entities, and the knowledge graph is traversed to select a candidate entity as a result entity, the efficiency of knowledge graph reasoning is relatively low.

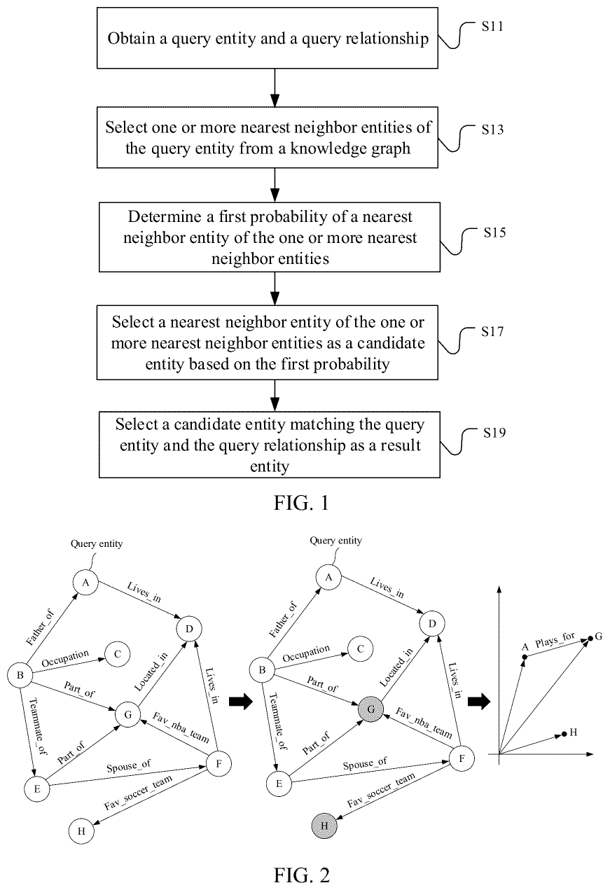

Implementations of the present specification provide a knowledge graph reasoning method, which improves the efficiency of knowledge graph reasoning. The knowledge graph reasoning method can be applied to a computer device or system. The computer device or system includes but is not limited to a personal computer, a server, a server cluster including a plurality of servers, etc. Referring to FIG. 1, the knowledge graph reasoning method can include the following steps.

Step S11: Obtain a query entity and a query relationship.

In some implementations, the query entity can be an entity in a knowledge graph, and the query relationship can be an entity relationship in the knowledge graph. In the knowledge graph, the query entity and the query relationship can be in or not in communication.

In some implementations, the knowledge graph is often incomplete due to various factors. As a result, although a certain entity and a certain entity relationship are not in communication in the knowledge graph, in the real world, there is still the possibility that the entity is in communication with the entity relationship. In other words, in the real world, there is still the possibility that the entity and the entity relationship can be matched to form a triplet.

For example, in the real world, there is entity relationship r between entity h and entity t. However, during construction of the knowledge graph, communication between entity h and entity relationship r and communication between entity relationship r and entity t are not observed. As a result, in the constructed knowledge graph, there is no communication between entity h and entity relationship r, and there is no communication between entity relationship r and entity t. For example, in the real world, user A is the father of user B. However, in the knowledge graph, there is no communication between the entity “user A” and the entity relationship “father”, and there is no communication between the entity relationship “father” and the entity “user B”.

In some implementations, the query entity and the query relationship can be used to find a result entity. The query entity, the query relationship, and the result entity can be matched to form a triplet. The triplet can exist in the knowledge graph, or the triplet possibly does not exist in the knowledge graph due to incompleteness of the knowledge graph. The query entity can be a head entity, and the result entity can be a tail entity; or the query entity can be the tail entity, and the result entity can be the head entity. For example, the query entity, the query relationship, and the result entity can be matched for form a triplet (A, Plays_for, G), where A represents the query entity, Plays_for represents the query relationship, and G represents the result entity.

In some implementations, a query entity and a query relationship input by a user can be received. For example, the user can input the query entity and the query relationship, and the query entity and the query relationship input by the user can be received. Alternatively or additionally, the user can input a query statement, the query statement input by the user can be received, and semantic analysis can be performed on the received query statement to obtain the query entity and the query relationship. For example, the user can input a query statement “Who is the father of Emperor Wu of Han”, the query statement can be received, and semantic analysis can be performed on the received query statement to obtain a query entity “Emperor Wu of Han” and a query relationship “father”.

Certainly, a query entity and a query relationship sent from another device can also be received. The another device can include a terminal device such as a smartphone, a personal computer, etc. For example, the another device can send the query entity and the query relationship, and the query entity and the query relationship sent from the another device can be received. Alternatively or additionally, the another device can send a query statement, the query statement sent from the another device can be received, and semantic analysis can be performed on the received query statement to obtain the query entity and the query relationship.

Step S13: Select one or more nearest neighbor entities of the query entity from a knowledge graph.

In some implementations, considering that the result entity is often located near the query entity, the nearest neighbor entity of the query entity can be selected from the knowledge graph. As such, an entity in the knowledge graph can be screened based on the query entity to avoid traversing the entire knowledge graph when the result entity is selected, thereby reducing the number of candidate entities and improving the efficiency of knowledge graph reasoning.

In some implementations, an entity whose proximity to the query entity is less than or equal to a K1 order can be selected as a nearest neighbor entity. The proximity can be represented by an order, and the order can include the number of edges in the shortest path between entities. For example, if the shortest path between two entities includes K edges, it can be considered that proximity between the two entities is a K order. One entity can be referred to as a K-order nearest neighbor entity of another entity. A value of K1 can be positively correlated to the number of nearest neighbor entities, and a specific value of K1 can be set flexibly based on an actual requirement, for example, can be 3, 4, 6, 8, 9, etc.

For example, in a knowledge graph shown in FIG. 2, nodes A, B, C, etc. represent entities, and edges (for example, Father_of, Lives_in, etc.) between the nodes represent entity relationships. In the knowledge graph shown in FIG. 2, entity A is the query entity, and entity B to entity H are nearest neighbor entities of entity A. Entity B and entity D are first-order nearest neighbor entities of entity A, entity C, entity G, entity E, entity F are second-order nearest neighbor entities of entity A, and entity H is a third-order nearest neighbor entity of entity A.

Certainly, the proximity can also be represented in other ways. For example, the proximity can be represented by the number of edges in the longest path between entities. The nearest neighbor entity of the query entity can be selected from the knowledge graph in other ways.

Step S15: Determine a first probability of a nearest neighbor entity of the one or more nearest neighbor entities.

In some implementations, there can be a plurality of types of entities in the knowledge graph. For example, the types of the entities in the knowledge graph can include “human”, “object”, “animal”, “geographical location”, etc. The query relationship can reflect a possible type of the result entity to some extent. For example, based on a query relationship “father”, it can be reasoned that the type of the result entity can be “human” or “animal”, but not “object” or “geographical location”. Therefore, if the nearest neighbor entity is screened based on the query relationship, the number of candidate entities can be further reduced, and the efficiency of knowledge graph reasoning can be improved.

However, the knowledge graph is often incomplete. If a nearest neighbor entity in communication with the query relationship is obtained as a candidate entity directly based on communication between entities in the knowledge graph, a nearest neighbor entity is possibly omitted, which reduces the accuracy of knowledge graph reasoning. For example, although the query relationship is not in communication with a certain nearest neighbor entity in the knowledge graph, in the real world, there is still the possibility that the query relationship is in communication the nearest neighbor entity. The nearest neighbor entity is still likely to be the result entity.

Therefore, the first probability of each nearest neighbor entity can be determined to screen the nearest neighbor entity based on the first probability, thereby improving the accuracy of knowledge graph reasoning. The first probability is used to indicate a possibility that the nearest neighbor entity is in communication with the query relationship. A value of the first probability is positively correlated to the possibility. For example, the first probability can be a real number within an interval [0, 1], where 0 indicates that the nearest neighbor entity is not in communication with the query relationship, and 1 indicates that the nearest neighbor entity is in communication with the query relationship.

In some implementations, there are one or more nearest neighbor entities. A sub-knowledge graph of each nearest neighbor entity can be extracted from the knowledge graph, type distribution information of the nearest neighbor entity can be determined based on the sub-knowledge graph and a type distribution prediction model, and the first probability of the nearest neighbor entity can be determined based on the type distribution information and the query relationship.

An entity whose proximity to the nearest neighbor entity is less than or equal to a K2 order can be selected from the knowledge graph, and the sub-knowledge graph can be extracted from the knowledge graph, where the sub-knowledge graph includes the entity less than or equal to the K2 order. A value of K2 can be positively correlated to a scale of the sub-knowledge graph, and a specific value of K2 can be set flexibly based on an actual requirement, for example, can be 3, 5, 6, 10, etc. Certainly, the proximity can also be represented in other ways so that an entity can be selected from the knowledge graph in other ways to extract the sub-knowledge graph based on the selected entity.

Certainly, the sub-knowledge graph of the nearest neighbor entity can also be selected from the knowledge graph in other ways.

For example, an entity whose proximity to the nearest neighbor entity is less than or equal to the K2 order and an entity whose proximity to the nearest neighbor entity is greater than the K2 order and less than or equal to a K3 order can be selected from the knowledge graph. Richness of entity relationship types is more important for the type distribution prediction model, and therefore, for the entity whose proximity is greater than the K2 order and less than or equal to the K3 order, the entity can be retained if an entity relationship in communication with the entity is different from an entity relationship in communication with the nearest neighbor entity; or the entity can be ignored if the entity relationship in communication with the entity is the same as the entity relationship in communication with the nearest neighbor entity. As such, the sub-knowledge graph can be extracted from the knowledge graph based on the entity whose proximity is less than or equal to the K2 order and the retained entity whose proximity is greater than the K2 order and less than or equal to the K3 order.

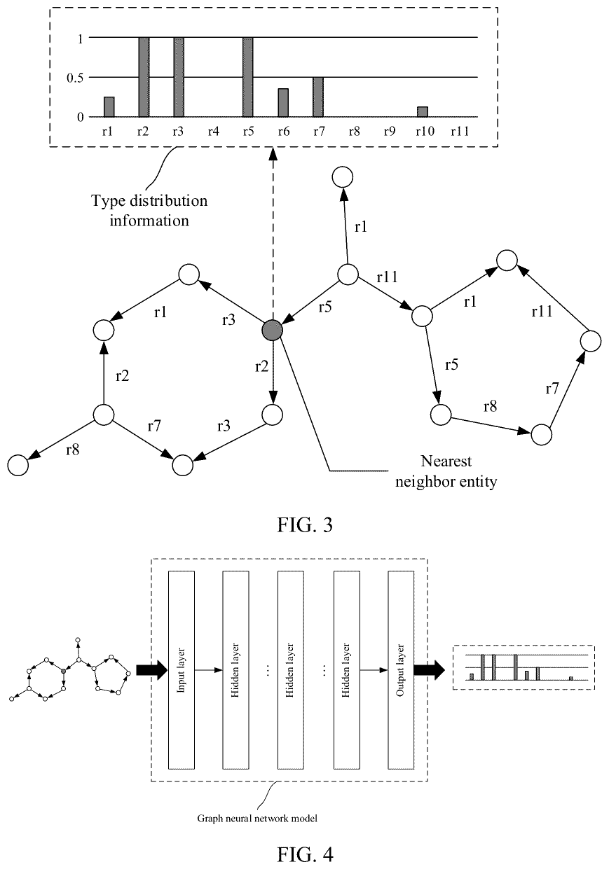

The type distribution information is used to indicate possibilities that the nearest neighbor entity is in communication with a plurality of known entity relationships. The type distribution information can include probability distribution of the nearest neighbor entity in the plurality of known entity relationships. The plurality of known entity relationships can, e.g., include various types of entity relationships in the knowledge graph. The plurality of known entity relationships can include an entity relationship in communication with the nearest neighbor entity in the knowledge graph, and can also include an entity relationship not in communication with the nearest neighbor entity in the knowledge graph. For example, entity relationships in the knowledge graph can be deduplicated to obtain the plurality of known entity relationships. For example, in a knowledge graph shown in FIG. 3, a gray-colored entity represents the nearest neighbor entity. The knowledge graph shown in FIG. 3 includes 11 entity relationships r1 to r11. The type distribution information includes probability distribution of the nearest neighbor entity in the 11 entity relationships. The probability that the nearest neighbor entity is in communication with entity relationship r1 is 0.2, the probability that the nearest neighbor entity is in communication with entity relationship r2 is 1, the probability that the nearest neighbor entity is in communication with entity relationship r3 is 0.2, the probability that the nearest neighbor entity is in communication with entity relationship r4 is 0, the probability that the nearest neighbor entity is in communication with entity relationship r5 is 1, the probability that the nearest neighbor entity is in communication with entity relationship r6 is 0.3, the probability that the nearest neighbor entity is in communication with entity relationship r7 is 0.5, the probability that the nearest neighbor entity is in communication with entity relationship r8 is 0, the probability that the nearest neighbor entity is in communication with entity relationship r9 is 0, the probability that the nearest neighbor entity is in communication with entity relationship r10 is 0.1, and the probability that the nearest neighbor entity is in communication with entity relationship r11 is 0.

The type distribution prediction model can be used to determine the type distribution information. The type distribution prediction model can include a graph neural network (GNN) model, a multilayer perceptron (MLP), etc. Graph structure data of the sub-knowledge graph can be input to the graph neural network model to obtain the type distribution information of the nearest neighbor entity. The graph structure data can include an embedding representation of an entity and an embedding representation of an entity relationship. The embedding representation can include a vector, etc.

For example, referring to FIG. 4, the graph neural network model can include an input layer, a plurality of hidden layers, and an output layer. The input layer is used to input the graph structure data to the hidden layer. The hidden layer is used to update the embedding representation of the entity and the embedding representation of the entity relationship. The embedding representation of the entity and the embedding representation of the entity relationship are updated once in each of the hidden layers. For example, the hidden layer can update the embedding representation of the entity and the embedding representation of the entity relationship by using the following equations: mᵥⁱ=Σ_{eεN(v)}sₑⁱ and sₑⁱ⁺¹=σ([mᵥⁱ, mᵤⁱ, sₑⁱ]·Wⁱ+bⁱ)·sₑⁱ represents an embedding representation of entity relationship e, N(v) represents a set formed by entity relationships in communication with entity v, mᵥⁱ represents an embedding representation of entity v, sₑⁱ⁺¹ represents an updated embedding representation of entity relationship e, mᵤⁱ represents an embedding representation of entity u, v, u∈N(e), N(e) represents a set formed by entities in communication with entity relationship e, N (e) includes two entities v and u, [ ] represents a splice operation, Wⁱ represents a transformation matrix, bⁱ represents a bias vector, and a represents a ReLU function. The output layer can be understood as a multi-classifier. The output layer is used to classify nearest neighbor entities based on embedding representations of the nearest neighbor entities to obtain probability distribution of the nearest neighbor entities in a plurality of known entity relationships.

For a process of training the type distribution prediction model, references can be made to subsequent implementations.

The type distribution information can include probability distribution of the nearest neighbor entity in a plurality of known entity relationships. The plurality of known entity relationships can include the query relationship. The first probability of the nearest neighbor entity can be determined based on the type distribution information and the query relationship. For example, a corresponding probability can be obtained from the type distribution information as the first probability based on the query relationship. For example, referring to FIG. 3, the type distribution information can include probability distribution of the nearest neighbor entity in the 11 entity relationships r1 to r11. The query relationship can be entity relationship r1. The probability that the nearest neighbor entity is in communication with entity relationship r1 can be obtained as the first probability.

Step S17: Select a nearest neighbor entity of the one or more nearest neighbor entities as a candidate entity based on the first probability.

In some implementations, one or more nearest neighbor entities can be selected as candidate entities from one or more nearest neighbor entities directly based on the first probability. For example, one or more nearest neighbor entities with the largest first probability can be selected as candidate entities.

In some implementations, a second probability of the nearest neighbor entity can be further calculated based on the first probability and a degree of the nearest neighbor entity, and a nearest neighbor entity can be selected as the candidate entity based on the second probability. The degree of the nearest neighbor entity can include the number of entity relationships in communication with the nearest neighbor entity. For example, graph data corresponding to the knowledge graph can be directed graph data, and the degree of the nearest neighbor entity can include the sum of an outdegree and an indegree of a node corresponding to the nearest neighbor entity. For another example, the graph data corresponding to the knowledge graph can be undirected graph data, and the degree of the nearest neighbor entity can include the number of edges of the node corresponding to the nearest neighbor entity. A larger number of entity relationships in communication with the nearest neighbor entity indicates a higher possibility that the nearest neighbor entity is the candidate entity. As such, the second probability is used to more accurately selects the candidate entity.

Mathematical operations such as addition and multiplication can be performed on the first probability and the degree of the nearest neighbor entity to obtain the second probability of the nearest neighbor entity. For example, the first probability of the nearest neighbor entity can be p(r|e), and the degree of the nearest neighbor entity can be p(e). The second probability can be calculated based on an equation p(e|r)=p(e)×p(r|e), where p(e|r) represents the second probability, r represents the query relationship, and e represents the nearest neighbor entity.

One or more nearest neighbor entities with the largest second probability can be selected from one or more nearest neighbor entities as candidate entities.

For example, in the knowledge graph shown in FIG. 2, entity A is the query entity, and entity B to entity H are nearest neighbor entities of entity A. Nearest neighbor entity G and nearest neighbor entity H can be selected from nearest neighbor entity B to nearest neighbor entity H as candidate entities.

Step S19: Select a candidate entity matching the query entity and the query relationship as a result entity.

In some implementations, there are one or more candidate entities, the result entity can be selected from the one or more candidate entities, and the result entity, the query entity, and the query relationship can be matched to form a triplet.

In some implementations, for each candidate entity, a candidate triplet can be constructed based on the candidate entity, the query entity, and the query relationship. The number of candidate triplets can be equal to the number of candidate entities. A confidence of the candidate triplet can be determined. The confidence is used to indicate a degree of confidence that the candidate triplet can be established. A candidate triplet can be selected as a target triplet based on the confidence, and a candidate entity in the target triplet can be determined as the result entity.

The confidence of the candidate triplet can be determined by using a rule-based reasoning method or a representation learning-based reasoning method. Using the representation learning-based reasoning method as an example, the confidence of the candidate triplet can be determined based on an embedding representation of the query entity, an embedding representation of the candidate entity, and an embedding representation of the query relationship in the candidate triplet. For example, the embedding representation of the query entity can be subtracted from the embedding representation of the candidate entity, a subtraction result can be compared with the embedding representation of the query relationship, and the confidence of the candidate triplet can be determined based on a comparison result. If the subtraction result is closer to the embedding representation of the query relationship, the confidence of the candidate triplet is higher. Certainly, the candidate triplet can be scored by using a scoring function based on the embedding representation of the query entity, the embedding representation of the candidate entity, and the embedding representation of the query relationship, and a score can be used as the confidence of the candidate triplet.

A candidate triplet with the highest confidence can be selected as the target triplet from one or more candidate triplets.

For example, referring to FIG. 2, candidate entity G, query entity A, and query relationship Plays_for can constitute candidate triplet triad1, and candidate entity H, query entity A, and query relationship Plays_for can constitute candidate triplet triad2. An embedding representation of candidate entity G is subtracted from an embedding representation of query entity A, and a subtraction result is close to an embedding representation of query relationship Plays_for. Therefore, candidate triplet triad1 has a higher confidence. An embedding representation of candidate entity H is subtracted from the embedding representation of query entity A, and a subtraction result is significantly different from the embedding representation of query relationship Plays_for. Therefore, candidate triplet triad2 has a lower confidence. Candidate triplet triad1 can be selected as the target triplet, and candidate entity G in the target triplet can be used as the result entity.

According to the knowledge graph reasoning method in this implementation of the present specification, the query entity and the query relationship can be obtained, the nearest neighbor entity of the query entity can be selected from the knowledge graph, the first probability of the nearest neighbor entity can be determined, the nearest neighbor entity can be selected as the candidate entity based on the first probability, and the candidate entity matching the query entity and the query relationship can be selected as the result entity. As such, an entity in the knowledge graph can be screened based on the query entity to obtain the nearest neighbor entity, and the nearest neighbor entity can be screened based on the first probability to obtain the candidate entity. Therefore, the number of candidate entities can be reduced, and the efficiency of knowledge graph reasoning can be improved.

An implementation of the present specification further provides a model training method. The model training method can be applied to a computer device. The computer device includes but is not limited to a personal computer, a server, a server cluster including a plurality of servers, etc.

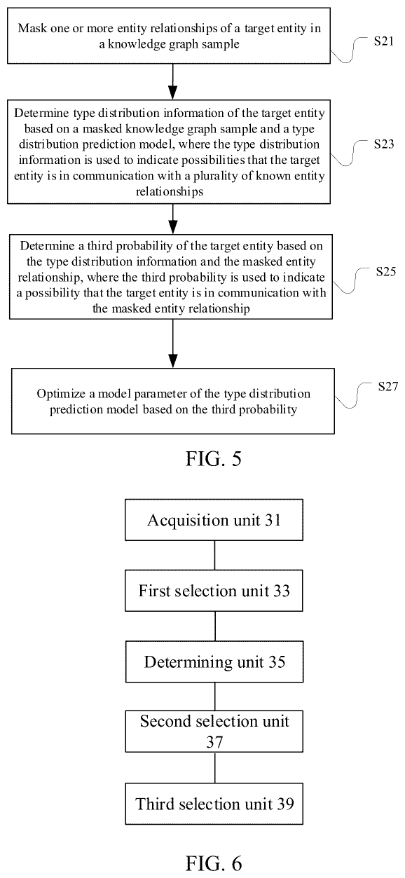

Referring to FIG. 5, the model training method can include the following steps.

Step S21: Mask one or more entity relationships of a target entity in a knowledge graph sample.

In some implementations, there can be a plurality of knowledge graph samples.

A plurality of knowledge graphs can be obtained as knowledge graph samples, and one entity can be selected from each knowledge graph sample as a target entity. Alternatively or additionally, a plurality of entities can be selected from the knowledge graph as target entities, and a sub-knowledge graph of each target entity can be extracted from the knowledge graph as a knowledge graph sample. For a process of extracting the sub-knowledge graph of the target entity, references can be made to the process of extracting the sub-knowledge graph of the nearest neighbor entity in the above implementation. Details are omitted herein for simplicity.

In some implementations, the knowledge graph sample can include the target entity. The entity relationship of the target entity can include an entity relationship in communication with the target entity. One or more entity relationships of the target entity can be masked. In some implementations, all entity relationships of the target entity can be masked, or any one or more entity relationships of the target entity can be masked. The masking can include deleting, etc.

Using the knowledge graph shown in FIG. 3 as an example, a gray-colored entity is the target entity. The entity relationship of the target entity can include r2, r3, r5, etc., and entity relationships r3 and r5 of the target entity can be masked.

Step S23: Determine type distribution information of the target entity based on a masked knowledge graph sample and a type distribution prediction model, where the type distribution information is used to indicate possibilities that the target entity is in communication with a plurality of known entity relationships.

In some implementations, the type distribution prediction model can include a graph neural network model, a multilayer perceptron, etc. Graph structure data of the masked knowledge graph sample can be obtained, and the graph structure data can be input to the type distribution prediction model to obtain the type distribution information of the target entity. The graph structure data can include an embedding representation of an entity and an embedding representation of an entity relationship. The type distribution information is used to indicate possibilities that the target entity is in communication with a plurality of known entity relationships. The plurality of known entity relationships can, e.g., include various types of entity relationships in the knowledge graph sample.

Step S25: Determine a third probability of the target entity based on the type distribution information and the masked entity relationship, where the third probability is used to indicate a possibility that the target entity is in communication with the masked entity relationship.

In some implementations, the type distribution information includes probability distribution of the target entity in a plurality of known entity relationships. The plurality of known entity relationships include the masked entity relationship. The third probability of the target entity can be determined based on the type distribution information and the masked entity relationship. The third probability is used to indicate a possibility that the target entity is in communication with the masked entity relationship. In some implementations, a corresponding probability can be obtained from the type distribution information as the third probability based on the masked entity relationship.

Step S27: Optimize a model parameter of the type distribution prediction model based on the third probability.

In some implementations, the model parameter of the type distribution prediction model can be optimized directly based on the third probability. For example, a target probability can be set for the masked entity relationship, and the target probability is used to indicate a probability that the target entity is in communication with the masked entity relationship. For example, the target probability can be 1. Loss information can be calculated based on the third probability and the target probability, and the model parameter of the type distribution prediction model can be optimized based on the loss information. For example, the model parameter is optimized by using a backpropagation mechanism.

In some implementations, a fourth probability of the target entity can be further determined based on the type distribution information and an identified entity relationship, and the model parameter of the type distribution prediction model can be optimized based on the third probability and the fourth probability. The identified entity relationship can include an entity relationship not in communication with the target entity. Using the knowledge graph shown in FIG. 3 as an example, a gray-colored entity is the target entity. The identified entity relationship can include r1, r4, r6, r7, r8, r9, r10, and r11.

The type distribution information includes probability distribution of the target entity in a plurality of known entity relationships. The plurality of known entity relationships include the identified entity relationship. A corresponding probability can be obtained from the type distribution information as the fourth probability based on the identified entity relationship. The fourth probability is used to indicate a possibility that the target entity is in communication with the identified entity relationship.

Loss information can be calculated based on the third probability and the fourth probability by using a loss function, and the model parameter of the type distribution prediction model can be optimized based on the loss information. For example, the model parameter is optimized by using a backpropagation mechanism.

The loss function can include a cross entropy loss function, a mean square error loss function, etc. The loss function is used to constrain the third probability to be greater than the fourth probability. In some scenario examples, the loss function can be expressed as L=log[1+Σ_{i∈Ω}_{_{obs}}Σj_{εΩ}_{ᵤₙₒ} exp(γ(p^{j}−pⁱ+m))]. Ω_{obs} represents a set formed by observable entity relationships, Ωᵤₙₒ represents a set formed by unobservable entity relationships, p^{j} represents the probability that the target entity is in communication with entity relationship j in set Ωᵤₙₒ, pⁱ represents the probability that the target entity is in communication with entity relationship i in set Ω_{obs}, p^{j} and pⁱ can be obtained from the type distribution information, and γ and m are hyperparameter. The observable entity relationship can be understood as an entity relationship in communication with the target entity in the knowledge graph sample, and the unobservable entity relationship can be understood as an entity relationship not in communication with the target entity in the knowledge graph sample. A union of sets Ω_{obs} and Ωᵤₙₒ can include various types of entity relationships in the knowledge graph sample. In addition, it should be noted that set Ω_{obs} can include the masked entity relationship. Certainly, set Ω_{obs} can, alternatively or additionally, include an unmasked entity relationship in communication with the target entity. Set Ωᵤₙₒ can include the identified entity relationship. In addition, the calculation equation of the loss function is merely an example, and there can be other variations or changes in practice.

In some implementations, step S21 to step S27 can be iteratively performed until an iteration end condition is satisfied. The iteration end condition can include that the number of iterations reaches a predetermined number of times. A better model parameter can be obtained through one iteration.

According to the model training method in this implementation of the present specification, the entity relationship of the target entity in the knowledge graph sample is masked to train the type distribution prediction model. As such, the type distribution prediction model can be trained in a self-monitoring way without labeling the knowledge graph sample. The trained type distribution prediction model is used to determine the type distribution information.

Referring to FIG. 6, an implementation of the present specification further provides a knowledge graph reasoning apparatus, including the following units: an acquisition unit 31, configured to obtain a query entity and a query relationship; a first selection unit 33, configured to select one or more nearest neighbor entities of the query entity from a knowledge graph; a determining unit 35, configured to determine a first probability of a nearest neighbor entity of the one or more nearest neighbor entities, where the first probability is used to indicate a possibility that the nearest neighbor entity is in communication with the query relationship; a second selection unit 37, configured to select a nearest neighbor entity of the one or more nearest neighbor entities as a candidate entity based on the first probability; and a third selection unit 39, configured to select a candidate entity matching the query entity and the query relationship as a result entity.

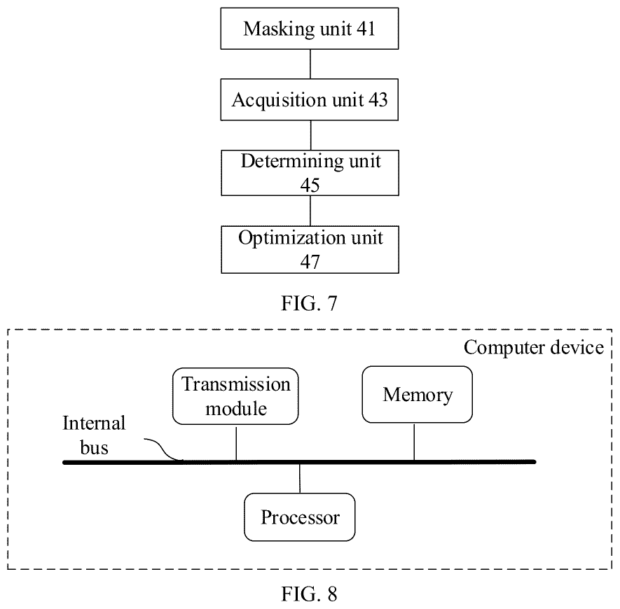

Referring to FIG. 7, an implementation of the present specification further provides a model training apparatus, including the following units: a masking unit 41, configured to mask one or more entity relationships of a target entity in a knowledge graph sample; an acquisition unit 43, configured to determine type distribution information of the target entity based on a masked knowledge graph sample and a type distribution prediction model, where the type distribution information is used to indicate possibilities that the target entity is in communication with a plurality of known entity relationships; a determining unit 45, configured to determine a third probability of the target entity based on the type distribution information and the masked entity relationship, where the third probability is used to indicate a possibility that the target entity is in communication with the masked entity relationship; and an optimization unit 47, configured to optimize a model parameter of the type distribution prediction model based on the third probability.

An implementation of a computer device in the present specification is described below. FIG. 8 is a schematic diagram illustrating a hardware structure of the computer device according to this implementation. As shown in FIG. 8, the computer device can include one or more processors (only one processor is shown in the figure), a memory, and a transmission module. Certainly, a person of ordinary skill in the art can understand that the hardware structure shown in FIG. 8 is merely an example and constitutes no limitation on the hardware structure of the computer device. In practice, the computer device can include more or fewer component units than those shown in FIG. 8, or have a configuration different from that shown in FIG. 8.

The memory can include a high-speed random access memory, or can further include a non-volatile memory, for example, one or more magnetic storage apparatuses, a flash memory, or another non-volatile solid state memory. Certainly, the memory can further include a remotely disposed network memory. The memory can be configured to store program instructions or modules of application software, for example, program instructions or modules in the implementation corresponding to FIG. 1 or FIG. 5 in the present specification.

The processor can be implemented in any proper way. For example, the processor can be in a form of a microprocessor or processor and a computer-readable medium that stores computer-readable program code (for example, software or firmware) that can be executed by the (microprocessor) processor, a logic gate, a switch, an application specific integrated circuit (ASIC), a programmable logic controller, an embedded microcontroller, etc. The processor can read and execute the program instructions or modules in the memory.

The transmission module can be configured to transmit data through a network, for example, transmit data through networks such as the Internet, the intranet, a local area network, and a mobile communication network.

The present specification further provides an implementation of a computer storage medium. The computer storage medium includes but is not limited to a random access memory (RAM), a read-only memory (ROM), a cache, a hard disk drive (HDD), a memory card, etc. The computer storage medium stores computer program instructions. When the computer program instructions are executed, program instructions or modules in the implementation corresponding FIG. 1 or FIG. 5 in the present specification are implemented.

It should be noted that the implementations of the present specification are described in a progressive way. For same or similar parts of the implementations, mutual references can be made to the implementations. Each implementation focuses on a difference from the other implementations In particular, the apparatus implementations, the computer device implementations, and the computer storage medium implementations are basically similar to the method implementations, description is relatively simple, and references can be made to parts of the method implementation descriptions. In addition, it can be understood that after reading the present specification document, a person skilled in the art can figure out any combination of some or all of the implementations enumerated in the present specification without making innovative efforts, and these combinations also fall within the scope disclosed and protected by the present specification.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

The system, apparatus, module, or unit illustrated in the previous implementations can be, e.g., implemented by using a computer chip or an entity, or can be implemented by using a product having a certain function. A typical implementation device is a computer. For example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

It can be learned from the descriptions of the above implementations that a person skilled in the art can clearly understand that the present specification can be implemented by software plus a necessary hardware platform, general or dedicated. Based on such an understanding, the technical solutions in the present specification essentially or the part contributing to the existing technologies can be implemented in a form of a software product. The computer software product can be stored in a storage medium, such as a ROM/RAM, a magnetic disk, or an optical disc, and includes several instructions for instructing a computer device (which can be a personal computer, a server, a network device, etc.) to perform the methods described in the implementations or in some parts of the implementations of the present specification.

The present specification can be applied to many general-purpose or dedicated computer system environments or configurations, for example, a personal computer, a server computer, a handheld or portable device, a tablet device, a multi-processor system, a microprocessor-based system, a set-top box, a programmable consumption electronic device, a network PC, a minicomputer, a mainframe computer, and a distributed computing environment including any of the above systems or devices.

The present specification can be described in the general context of computer-executable instructions executed by a computer, for example, a program module. Generally, the program module includes a routine, a program, an object, a component, a data structure, etc. executing a specific task or implementing a specific abstract data type. The present specification can also be practiced in distributed computing environments in which tasks are performed by remote processing devices that are connected through a communications network. In the distributed computing environments, the program module can be located in local and remote computer storage media including storage devices.

Although the present specification is described by using the implementations, a person of ordinary skill in the art knows that many variations of the present specification can be made without departing from the spirit of the present specification. It is expected that the appended claims include these variations without departing from the spirit of the present specification.

What is claimed is:

1. A method, comprising:
obtaining a query entity and a query relationship;
selecting one or more nearest neighbor entities of the query entity from a knowledge graph;
determining a first probability of a nearest neighbor entity of the one or more nearest neighbor entities, the first probability being used to indicate a possibility that the nearest neighbor entity is in communication with the query relationship;
selecting a nearest neighbor entity of the one or more nearest neighbor entities as a candidate entity based on the first probability; and
selecting a candidate entity matching the query entity and the query relationship as a result entity.

2. The method according to claim 1, wherein the selecting the one or more nearest neighbor entities of the query entity from the knowledge graph includes:
selecting an entity whose proximity to the query entity is less than or equal to a K1 order from the knowledge graph as a nearest neighbor entity.

3. The method according to claim 1, wherein the determining the first probability of the nearest neighbor entity includes:
determining type distribution information of the nearest neighbor entity, wherein the type distribution information indicates possibilities that the nearest neighbor entity is in communication with a plurality of known entity relationships; and
determining the first probability of the nearest neighbor entity based on the type distribution information and the query relationship.

4. The method according to claim 3, wherein the determining the type distribution information of the nearest neighbor entity includes:
extracting a sub-knowledge graph of the nearest neighbor entity from the knowledge graph; and
determining the type distribution information of the nearest neighbor entity based on the sub-knowledge graph and a type distribution prediction model.

5. The method according to claim 4, wherein the extracting the sub-knowledge graph of the nearest neighbor entity from the knowledge graph includes:
selecting one or more entities each having proximity to the nearest neighbor entity less than or equal to a K2 order from the knowledge graph; and
extracting a sub-knowledge graph that includes the one or more entities each having proximity to the nearest neighbor entity less than or equal to the K2 order.

6. The method according to claim 4, wherein the type distribution prediction model includes a graph neural network model; and
the determining the type distribution information of the nearest neighbor entity includes:
inputting graph structure data of the sub-knowledge graph to the graph neural network model to obtain the type distribution information of the nearest neighbor entity, wherein the graph structure data includes an embedding representation of an entity and an embedding representation of an entity relationship.

7. The method according to claim 4, wherein the type distribution prediction model is obtained by training including:
masking one or more entity relationships of a target entity in a knowledge graph sample to obtain a masked knowledge graph sample;
determining type distribution information of the target entity based on the masked knowledge graph sample and the type distribution prediction model, wherein the type distribution information indicates possibilities that the target entity is in communication with a plurality of known entity relationships;
determining a third probability of the target entity based on the type distribution information and the masked entity relationship, wherein the third probability indicates a possibility that the target entity is in communication with the masked entity relationship; and
optimizing a model parameter of the type distribution prediction model based on the third probability.

8. The method according to claim 7, wherein the training further comprises:
determining a fourth probability of the target entity based on the type distribution information and an identified entity relationship, wherein the fourth probability indicates a possibility that the target entity is in communication with the identified entity relationship, and the identified entity relationship includes an entity relationship not in communication with the target entity; and
wherein the optimizing the model parameter of the type distribution prediction model includes:
optimizing the model parameter of the type distribution prediction model based on the third probability and the fourth probability.

9. The method according to claim 1, wherein the selecting a nearest neighbor entity of the one or more nearest neighbor entities as the candidate entity includes:
calculating a second probability of a nearest neighbor entity of the one or more nearest neighbor entities based on the first probability and a degree of the nearest neighbor entity; and
selecting a nearest neighbor entity of the one or more nearest neighbor entities as the candidate entity based on the second probability.

10. The method according to claim 1, wherein the selecting a candidate entity matching the query entity and the query relationship as the result entity includes:
constructing a candidate triplet based on a candidate entity, the query entity, and the query relationship;
selecting a candidate triplet as a target triplet based on a confidence of the candidate triplet; and
determining a candidate entity in the target triplet as the result entity.

11. The method according to claim 1, wherein the query entity is a head entity, and the result entity is a tail entity; or the query entity is the tail entity and the result entity is the head entity.

12. A method, comprising:
masking one or more entity relationships of a target entity in a knowledge graph sample;
determining type distribution information of the target entity based on a masked knowledge graph sample and a type distribution prediction model, wherein the type distribution information indicates possibilities that the target entity is in communication with a plurality of known entity relationships;
determining a first probability of the target entity based on the type distribution information and the masked entity relationship, wherein the first probability indicates a possibility that the target entity is in communication with the masked entity relationship; and
optimizing a model parameter of the type distribution prediction model based on the first probability.

13. The method according to claim 12, wherein further comprising:
determining a second probability of the target entity based on the type distribution information and an identified entity relationship, wherein the second probability indicates a possibility that the target entity is in communication with the identified entity relationship, and the identified entity relationship includes an entity relationship not in communication with the target entity; and
the optimizing the model parameter of the type distribution prediction model includes:
optimizing the model parameter of the type distribution prediction model based on the first probability and the second probability.

14. A computer system, comprising:
at least one processor; and
at least one memory device having executable instructions stored thereon, the executable instructions when executed by the at least one processor enabling the at least one processor to implement acts including:
obtaining a query entity and a query relationship;
selecting one or more nearest neighbor entities of the query entity from a knowledge graph;
determining a first probability of a nearest neighbor entity of the one or more nearest neighbor entities, the first probability being used to indicate a possibility that the nearest neighbor entity is in communication with the query relationship;
selecting a nearest neighbor entity of the one or more nearest neighbor entities as a candidate entity based on the first probability; and
selecting a candidate entity matching the query entity and the query relationship as a result entity.

15. The computer system according to claim 14, wherein the selecting the one or more nearest neighbor entities of the query entity from the knowledge graph includes:
selecting an entity whose proximity to the query entity is less than or equal to a K1 order from the knowledge graph as a nearest neighbor entity.

16. The computer system according to claim 14, wherein the determining the first probability of the nearest neighbor entity includes:
determining type distribution information of the nearest neighbor entity, wherein the type distribution information indicates possibilities that the nearest neighbor entity is in communication with a plurality of known entity relationships; and
determining the first probability of the nearest neighbor entity based on the type distribution information and the query relationship.

17. The computer system according to claim 16, wherein the determining the type distribution information of the nearest neighbor entity includes:
extracting a sub-knowledge graph of the nearest neighbor entity from the knowledge graph; and
determining the type distribution information of the nearest neighbor entity based on the sub-knowledge graph and a type distribution prediction model.

18. The computer system according to claim 17, wherein the extracting the sub-knowledge graph of the nearest neighbor entity from the knowledge graph includes:
selecting one or more entities each having proximity to the nearest neighbor entity less than or equal to a K2 order from the knowledge graph; and
extracting a sub-knowledge graph that includes the one or more entities each having proximity to the nearest neighbor entity less than or equal to the K2 order.

19. The computer system according to claim 17, wherein the type distribution prediction model includes a graph neural network model; and
the determining the type distribution information of the nearest neighbor entity includes:
inputting graph structure data of the sub-knowledge graph to the graph neural network model to obtain the type distribution information of the nearest neighbor entity, wherein the graph structure data includes an embedding representation of an entity and an embedding representation of an entity relationship.

20. The computer system according to claim 17, wherein the type distribution prediction model is obtained by training including:
masking one or more entity relationships of a target entity in a knowledge graph sample to obtain a masked knowledge graph sample;
determining type distribution information of the target entity based on the masked knowledge graph sample and the type distribution prediction model, wherein the type distribution information indicates possibilities that the target entity is in communication with a plurality of known entity relationships;
determining a third probability of the target entity based on the type distribution information and the masked entity relationship, wherein the third probability indicates a possibility that the target entity is in communication with the masked entity relationship; and
optimizing a model parameter of the type distribution prediction model based on the third probability.
